(19) United States
(12) Patent Application Publication
(10) Pub. No.: US 2015/0109097 A1
(43) Pub. Date: Apr. 23, 2015

(54) Electronically Controlled Locking System and Electronic Key for Controlling the Locking System

(71) Applicant: Airbus DS GmbH, Taufkirchen (DE)

(72) Inventor: Wolfgang KOGLER, Ottobrunn (DE)

(21) Appl. No.: 14/520,829

(22) Filed: Oct. 22, 2014

(30) Foreign Application Priority Data
Oct. 23, 2013 (DE) 10 2013 017 523.2

(51) Int. Cl. E05B 47/00; G07C 9/00

(52) U.S. Cl. CPC E05B 47/0001; G07C 9/00119
USPC 340/5.2; 70/275

(57) ABSTRACT

An electronically controlled locking system includes a receiver for receiving signals from one or more electronic keys, a locking and unlocking mechanism that can be controlled on the basis of signals received from electronic keys, and a transmitter for transmitting a message confirming the successful execution of a locking and/or unlocking process to the electronic key that initiated the unlocking and/or locking process.

### CROSS-REFERENCE TO RELATED APPLICATIONS

The present application claims priority under 35 U.S.C. §119 to German patent application 10 2013 017 523.2, filed Oct. 23, 2013, the entire disclosure of which is herein expressly incorporated by reference.

### BACKGROUND AND SUMMARY OF THE INVENTION

Exemplary embodiments of the invention relate to an electronically controlled locking system, as is used, for example, in a vehicle for locking and unlocking the vehicle doors, and an electronic key which can be used for controlling the locking system.

Electronic locking systems are used today in nearly every motor vehicle for locking and unlocking the vehicle doors. Such locking systems are not limited to the motor vehicles sector, however, and can be used just as effectively for locking and unlocking doors of buildings. In general, electronic locking systems are suitable as an alternative to mechanical locking systems.

In the case of motor vehicles, a radio remote controller for locking and unlocking is generally provided in the ignition key for the motor vehicle. Communication between the vehicle locking system and the radio remote controller is subjected to elaborate authentication procedures, to prevent unauthorized access to the locking system by intercepting radio communication between the radio remote controller and the locking system, for example. In most cases, the vehicle owner is notified when the vehicle doors have been locked or unlocked by a brief flashing of the vehicle lights, such as the directional lights or the headlights, and/or by a sound signal.

Exemplary embodiments of the present invention are directed to an enhanced electronic locking system and an electronic key for controlling the enhanced locking system.

An electronic vehicle key is generally understood herein as a portable device with which an electronically controlled locking system can be operated remotely, for example at a distance of several meters. The present invention is based on the understanding that many people pay no attention to the signaling of a locking or unlocking of a vehicle as described above, and therefore in all probability would not notice if, for example, the radio communication between vehicle key and locking system were to be intentionally disrupted by a third party so that a locking command issued by the vehicle key would not even be received by the locking system, and as a result, the vehicle would remain unlocked. To prevent this, the invention enhances an electronic locking system and an electronic key provided for controlling the system by integrating a confirmation function for confirming a locking and/or unlocking process of the electronically controlled locking system into the electronic key, so that a user actively receives a check-back signal regarding a successfully executed locking and/or unlocking process, and as a result, any potential deliberate disruptions of the locking and unlocking process can be better, particularly more easily, identified. Although the invention is not limited to this, the confirmation according to the invention of a successfully executed locking and/or unlocking process is particularly suitable for locking systems of (motor) vehicles. In general, however, the invention can be advantageously used in any electronically controlled locking system.

One embodiment of the invention relates to an electronically controlled locking system comprising a receiver for receiving signals from one or more electronic keys, a locking and unlocking mechanism that can be controlled on the basis of signals received from electronic keys, and a transmitter for transmitting a message confirming the successful execution of a locking or unlocking process to the electronic key that triggered the unlocking or locking process. A locking system of this type can be used, for example, in a vehicle, in particular in a motor vehicle, to enable the system to generate a check-back signal that is as secure as possible from manipulation and acknowledges a successful locking and/or unlocking process, which is not absolutely ensured with a check-back signal generated directly by a vehicle, for example, by a brief flashing of the vehicle lights, such as the directional lights or the headlights and/or by a sound signal generated by the vehicle. Moreover, the locking system is not limited to use in vehicles, and can instead be used universally for locking and/or unlocking doors, for example in a building.

The locking and unlocking mechanism in this case can be designed to generate a signal upon completion of a successfully executed locking and/or unlocking process and to transmit this signal to the transmitter, and the transmitter can be designed to generate the confirmation message upon receipt of the signal from the locking and unlocking mechanism and to transmit the message to the electronic key. Using a signal of this type allows security to be increased, since the signal is generated only upon completion of a successfully executed locking and/or unlocking process, whereby it can be ensured that the signal will be generated only when the locking and/or unlocking process has actually been completed successfully.

Receiver and transmitter can further be designed to receive and/or transmit encoded signals. The risk of manipulation of the system can thereby be reduced.

A further embodiment of the invention relates to an electronic key for a locking system according to the invention and as described herein, comprising a transmitter for transmitting a signal to the locking system for the purpose of initiating a locking and/or unlocking process in response to user input, a receiver for receiving a message from the locking system confirming the successful execution of a locking and/or unlocking process, and a signaling device controlled by the receiver for signaling the successful execution of the locking and/or unlocking process, to be detected by a user. A key of this type can be embodied, for example, in the form of a radio remote control key, such as are used today in many vehicles. In contrast to these conventional keys, the key according to the invention is enhanced by a confirmation function, so that a user can detect a successfully executed locking and/or unlocking process, even without receiving a check-back signal generated directly by the vehicle. The key can generally be implemented using a portable, i.e. mobile, electronic device, for example a smart phone, which has a transmitter and a receiver along with a signaling device. The transmitter and receiver can be implemented, for example, using a wireless communications unit, such as a WLAN-, Bluetooth® and/or infrared module.

The signaling device can be designed, in particular, to signal the successful execution of a locking and/or unlocking process haptically, visually or acoustically. For example, the signaling device can signal the successful execution of a locking and/or unlocking process by a vibration, by generating a sound signal and/or by a display, such as the activation of an LED.

Furthermore, the signaling device can be designed to actuate a vibration motor in response to a control signal from the receiver, which the receiver generates upon receipt of a message confirming successful execution of a locking and/or unlocking process.

The key can also be equipped with a rechargeable battery for supplying electric power to the transmitter, the receiver and the signaling device, and with a contactless charging device for charging the battery. In this manner, the increased consumption of power by the key as a result of the confirmation function can be covered. In the case of a vehicle key, the battery could be charged automatically during driving (for example, by magnetic coupling).

A further embodiment of the invention relates to a method for processing confirmation messages from an electronic locking system using a programmable mobile device according to the invention and as described herein, comprising the following steps: configuring a receiver of the programmable mobile device to receive a message from the locking system confirming the successful execution of a locking and/or unlocking process, and configuring a signaling device of the programmable mobile device to signal the successful execution of a locking and/or unlocking process for detection by a user.

A further embodiment of the invention relates to a computer program having program codes for implementing all the process steps according to the invention and as described herein, when the computer program is run on a computer.

One embodiment of the invention further relates to a data storage device in which the program code of the computer program according to the invention and described herein, which can be run on a computer, is stored.

Additional advantages and potential applications of the present invention are presented in the following description, in combination with the embodiment examples illustrated in the set of drawings.

The terms and the reference signs assigned thereto that are used in the list of reference signs provided herein are used in the description and in the drawings.

### BRIEF DESCRIPTION OF THE DRAWING FIGURE

FIG. 1 a block diagram of an embodiment example of an electronic locking system and an electronic key provided for the system, according to the invention.

### DETAILED DESCRIPTION

In the following description, similar, functionally similar and functionally interrelated elements are identified using the same reference signs. In the following, absolute values are indicated merely by way of example, and have no limiting effect on the invention.

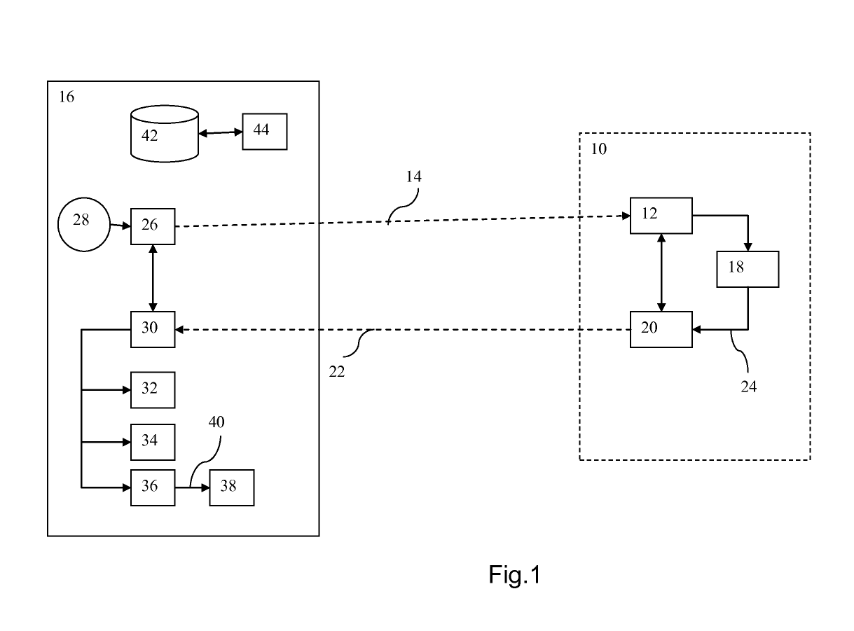

FIG. 1 shows a schematic block diagram of an electronic locking system 10, such as can be installed in a motor vehicle, for example. The locking system 10 comprises a radio receiver 12 for receiving radio signals 14 from an electronic key 16, a locking and unlocking mechanism 18 for vehicle doors, which mechanism can be controlled electronically by the radio receiver 12, and a radio transmitter 20 for transmitting a message confirming the successful execution of a locking/unlocking process to the key 16.

The locking system 10 can be embodied as a known electronic vehicle locking system, with the difference that it is additionally designed to generate and transmit messages confirming the successful execution of locking/unlocking processes to the requesting electronic key, as will be described in detail below.

The locking system 10 functions as follows: the radio receiver 12 is in a receiving mode, in which it is able to receive radio signals 14 for locking/unlocking from electronic keys 16, the radio signals 14 being encoded for the locking system 10. As soon as the receiver 12 receives an encoded locking/unlocking radio signal from the electronic key 16, it decodes the received signal in order to verify the authorization to lock/unlock the vehicle doors, and, with successful verification, actuates the locking and unlocking mechanism 18 to lock/unlock the doors. As soon as the locking/unlocking process has been completed by the locking and unlocking mechanism 18, the mechanism generates a locking/unlocking process completion signal 24, which is transmitted to the radio transmitter 20. The radio transmitter 20 also receives the code for the key 16 that initiated the locking/unlocking process from the radio receiver 12. Using the key code, the radio transmitter 20 generates a message 22 confirming successful execution of the locking/unlocking process, and transmits this message 22, encoded, to the electronic key 16, so that only this key or all keys that have the proper coding can decode this signal.

Radio receiver 12 and radio transmitter 20 of the locking system 10 can also be designed to communicate with electronic keys using wireless technologies, for example by means of infrared radiation or laser light radiation or by means of ultrasound. Alternatively or additionally, transmitter 12 and receiver 20 can be embodied as wired communications units, for example for communicating via a wired communications network, for example via a LAN (Local Area Network). An implementation of this type would be conceivable particularly for use in buildings, where doors could be controlled from PCs via a LAN, for example.

In the following, the configuration and the functioning of the electronic key 16 will be specified in detail. The key 16 has a button 28 for initiating a locking/unlocking process via the locking system 10, a radio transmitter 26 for transmitting locking/unlocking signals 14, a radio receiver 30 for receiving confirmation messages 22, a display 32, a sound generator 34, a vibration generator 36 and a vibration motor 38, a rechargeable battery 42 and a contactless charging device 44.

When the button 28 is activated by a user, the radio transmitter 26 generates a locking/unlocking radio signal 14 encoded for the locking system to initiate a locking/unlocking process via the locking system 10. At the same time or shortly after the locking/unlocking radio signal 14 has been transmitted, the radio transmitter 26 places the radio receiver 30 in a reception readiness mode, in particular for a predefined receiving period. The radio receiver 30 then waits, in particular during the predefined receiving period, for a confirmation signal 22 encoded with the code for the key, from the locking system 10. Once a confirmation signal 22 is received from the locking system confirming the successful execution of a locking/unlocking process, particularly within the predefined receiving period, the radio receiver 30 actuates the display 32, the sound generator 34 and/or the vibration generator 36. The user can be notified visually of the successfully executed locking/unlocking process via the display 32. The sound generator 34 can signal the successful execution of the locking/unlocking process to the user acoustically by a short sound signal. The vibration generator 36 can actuate the vibration motor 38 via a vibration control signal 40 such that the motor generates a short vibration of the key 16 to haptically inform the user of the successful execution of the locking/unlocking process. With these technical means, the user can thus receive a message directly from the key 16 as to whether the locking/unlocking process has been successfully executed.

The acoustic, visual and haptic check-back signaling capability of the key 16 can be applied alternatively or in combination. It is also possible for a locking process to have a different signal from an unlocking process. For example, a locking process could be signaled using a different sound signal and/or a different display, for example, a red light, from a locking process (e.g. green light).

Since these signaling options increase the power consumed by the electronic key 16 somewhat in practical use, the key can be equipped with a rechargeable battery 42, which is charged, for example, via a contactless charging device (e.g. magnetic coupling) while driving. In this manner, the increased power consumption can be compensated for.

The electronic key 16 can also be implemented in a programmable mobile device such as a smart phone. The advantage of a smart phone is that it already has suitable technical means for signaling a locking/unlocking process. Communication between smart phone and locking system could be implemented via proprietary or conventional communications technologies such as WLAN-, Bluetooth® and/or infrared. In this case, the functions of the electronic key 16 can be implemented using a computer program, which is run by the mobile device or generally by a computer, e.g. a PC. It would also be conceivable to implement the electronic key with a stationary or mobile PC, or a so-called tablet computer/PC. It is also conceivable to provide a program that will implement the process steps for processing confirmation messages from an electronic locking system according to the invention, as a so-called app that can be downloaded from the Internet and installed on a smart phone platform. Communication between the smart phone, which serves as the electronic key, and a locking system according to the invention could then be accomplished via radio technologies such as WLAN or Bluetooth® that are implemented in the smart phone. The screen of the smart phone could be used as a display, and the loudspeaker and the audio unit and the vibration unit could be used for signaling locking/unlocking processes successfully executed by the locking system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

### LIST OF REFERENCE SIGNS

10 electronically controlled locking system

12 radio receiver for locking/unlocking signal 18

14 locking/unlocking radio signal from an electronic key 16

16 electronic key

18 locking and unlocking mechanism

20 radio transmitter for confirmation message 22

22 confirmation message

24 locking/unlocking process completion signal

26 radio transmitter for locking/unlocking signal 14

28 button for initiating a locking/unlocking process

30 radio receiver for confirmation message 22

32 display

34 sound generator

36 vibration generator

38 vibration motor

40 vibration control signal

42 rechargeable battery

44 contactless charging device

What is claimed is:

1. An electronically controlled locking system, comprising:
a receiver configured to receive signals from one or more electronic keys;
a locking and unlocking mechanism controllable based on signals received from the one or more electronic keys; and
a transmitter configured to transmit a message confirming successful execution of a locking and/or unlocking process to the electronic key that triggered the unlocking or locking process.

2. The system of claim 1, wherein
the locking and unlocking mechanism is configured to generate a signal upon completion of a successfully executed locking and/or unlocking process, and to transmit the signal to the transmitter, and
the transmitter is configured to generate the confirmation message upon receipt of the signal from the locking and unlocking mechanism and to transmit the message to the electronic key.

3. The system of claim 1, wherein the receiver and transmitter are configured to receive and transmit encoded signals.

4. An electronic key for a locking system, the electronic key comprising:
a transmitter configured to transmit a signal to the locking system to initiate a locking and/or unlocking process in response to user input;
a receiver configured to receive a message confirming successful execution of a locking and/or unlocking process from the locking system; and
a signaling device controlled by the receiver and configured to signal the successful execution of a locking and/or unlocking process for detection by the user.

5. The electronic key of claim 4, wherein the signaling device haptically, visually or acoustically signals the successful execution of a locking and/or unlocking process.

6. The electronic key of claim 4, wherein the signaling device is configured to actuate a vibration motor in response to a control signal from the receiver, which the receiver generates upon receipt of a message confirming the successful execution of a locking and/or unlocking process.

7. The electronic key of claim 4, further comprising:
a rechargeable battery configured to supply electric power to the transmitter, the receiver and the signaling device, and
a contactless charging device configured to charge the rechargeable battery.

8. A method for processing confirmation messages from an electronic locking system using a programmable mobile device, the method comprising:
configuring a receiver of the programmable mobile device to receive a message from the electronic locking system confirming successful execution of a locking/unlocking process; and
configuring a signaling device of the programmable mobile device to signal the successful execution of a locking and/or unlocking process, for detection by a user.

9. The method of claim 8, further comprising:
receiving, by the receiver of the programmable mobile device, a message from the electronic locking system confirming successful execution of the locking/unlocking process; and
signaling, by the signaling device of the programmable mobile device, the successful execution of a locking and/or unlocking process.
